(19) United States
(12) Patent Application Publication
(10) Pub. No.: US 2011/0290964 A1
(43) Pub. Date: Dec. 1, 2011

(54) Novel Enhanced Connecting Brackets for Floating Rings

(75) Inventors: Johannes Nikolaus Laing, La Jolla, CA (US); Inge Laing, La Jolla, CA (US)

(73) Assignee: Pyron Solar III, LLC, Bakersfield, CA (US)

(21) Appl. No.: 13/049,562

(22) Filed: Mar. 16, 2011

Related U.S. Application Data
(63) Continuation of application No. 11/740,854, filed on Apr. 26, 2007, now abandoned.
(60) Provisional application No. 60/795,666, filed on Apr. 27, 2006.

(51) Int. Cl. F16M 13/02

(52) U.S. Cl. 248/205.1

(57) ABSTRACT

Briefly stated, floating rings which rotate around their vertical axis with predetermined relation to the azimuthal velocity of the sun are prevented from getting out of range by maintaining a desired spatial orientation between at least three fixed rollers circumferentially positioned. The present disclosure keeps floating rings together by encircling them.

### CROSS-REFERENCES TO RELATED APPLICATIONS

This application claims the benefit of and full Paris Convention Priority from U.S. Provisional Application Ser. No. 60/795,666, filed Apr. 27, 2006, the contents of which are incorporated by reference herein in its entirety, as fully set forth herein.

### BACKGROUND OF THE INVENTION

Solar Power plants, with floating rings have been known which rotate around their vertical axis with the azimuthal velocity of the sun. A method to prevent the rings from getting out of range is to keep the rings between three fixed rollers arranged at the circumference. Prior to the advent of the instant teachings, this need remained unaddressed.

### BRIEF SUMMARY OF THE INVENTION

Briefly stated, floating rings, which rotate around their vertical axis with predetermined relation to the azimuthal velocity of the sun are prevented from getting out of range by maintaining a desired spatial orientation between, for example, at least three fixed rollers circumferentially positioned.

According to embodiments of the present disclosure, there is provided in a solar power plant with floating rings rotating about vertical axes with the azimuthal velocity of the sun, the improvement comprising: connecting brackets to fix the position of a ring floating on a water layer, characterized in that the ring is held between rollers whose axes run almost vertical.

According to the embodiment of a novel at least two rings enhanced bracket system for floating rings, comprising, in combination; at least two rings; a connecting bracket fixed to the ground; and a gear motor and sprocket arrangement linked operatively to a roller chain on the outer periphery, rollers on the bracket contacting the inner circumference; whereby floating rings are prevented from travel outside of a specified range.

According to a connecting bracket set for a floating ring based solar energy system, which comprises, in combination, a connecting bracket for fixing the position of at least a ring floating of a water layer, said at least a ring being held between rollers having a substantially vertical axis; whereby tracking the azimuthal velocity of the sun is enabled by preventing the at least a ring from migrating outside of a predetermined range, by encircling the same.

### BRIEF DESCRIPTION OF THE DRAWINGS

The above-mentioned features and objects of the present disclosure will become more apparent with reference to the following description taken in, conjunction with the accompanying drawings wherein like reference numerals denote like elements and in which:

FIG. 1 shows an arrangement with only one connecting bracket;

FIG. 2 shows a vertical cross- section;

FIG. 3 shows an arrangement, which holds two rings together;

FIG. 4 shows a vertical cross-section of FIG. 3;

FIG. 5 shows a group of floating tubes, which supports the connecting bracket;

FIG. 6 shows a group of three rings, which are kept together by three connecting brackets.

### DETAILED DESCRIPTION OF THE INVENTION

The present inventors have discovered that solar power plants with floating rings rotating about their vertical axis with the azimuthal velocity tracking of the sun are functional to harvest solar energy, and herewith provide optimized systems to maintain a proper spatial orientation of the floating rings.

Expressly incorporated by reference as if fully satisfied herein are: U.S. Patent Nos. 5,772,791; 5,665,174 and 5,445,177. Likewise, PCT/EP93/00368; PCT/EP2002/011309; CN 1,568,550; and DE 10302 746 A1; DE 10318036; DE 10346164; and U.S. 2005/0284146, each assigned to the present inventors, are expressly incorporated by reference herein, as if each was set forth herein.

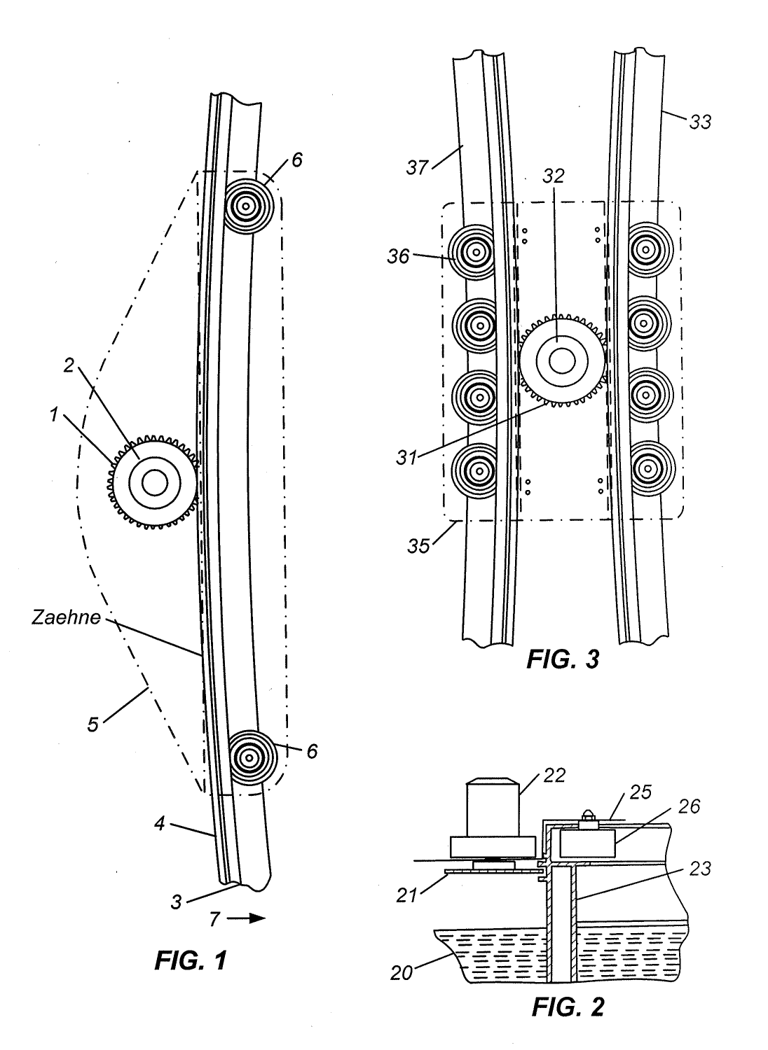

FIG. 1 shows a top view of a connecting bracket according to the invention which is fixed to the ground and which takes care of the movement needed to compensate for the azimuthal velocity. Thereby the gear motor 2 will drive the sprocket 1. Sprocket 1 transfers the torque to the ring 3, which is only partially shown. The teeth of the sprocket 1 engage into the roller chain 4 at the outer periphery. Sprocket 1 is positioned below a bracket 5 on which rollers 6, which are positioned close to each other are also fixed. These rollers contact the inner circumference and prevent the floating ring 3 from moving in direction 7.

FIG. 2 shows a cross-section of the device in FIG. 1 in a schematic presentation. The connecting bracket is positioned above water body 20 and is connected to the ground. The floating ring 23 is fixed in radial direction between sprocket 21 and rollers 26. The bracket 25 clamps sprocket 21 and gear motor 22 together.

FIG. 3 shows the bracket 35 of a connecting bracket, which keeps the two adjacent floating rings 33 and 37 together and at the same time, transfers the rotating movement of the gear motor 32 via sprocket 31 to the two floating rings 33 and 37. Rollers 36 prevent movement in radial direction as long as the ring is kept in its horizontal position by the water body.

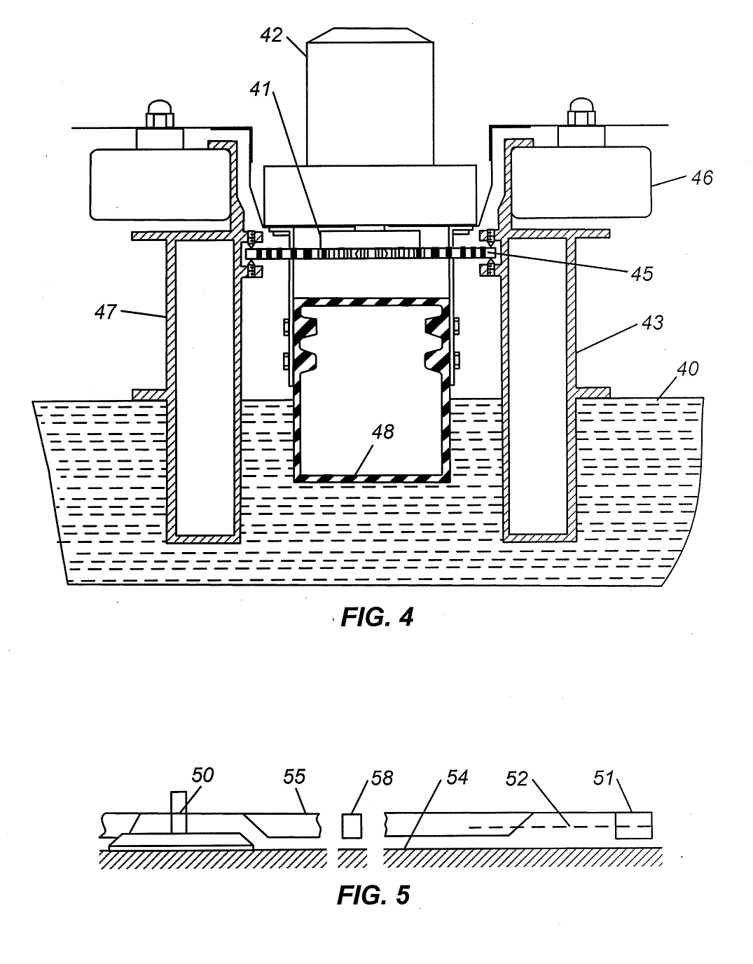

FIG. 4 shows the arrangement according to FIG. 3 in a vertical cross-section. Sprocket 41 is driven by gear motor 42 and transfers the torque onto sprocket 45 formed by a roller chain. Sprocket 41 and rollers 46 clamp floating rings 43 and 47 together to make a connection between the horizontally aligned rings in the water body 40. Below this device a hollow rectangular tube 48 is positioned whose buoyancy supports the connecting brackets.

FIG. 5 shows the floating tube 48 of FIG. 4 in cross-section 58. Tube 55 is connected to plate 50 in the central region between the three platforms. The end of the tube is connected to a concrete weight 51, which prevents it from getting out of place. The tube submerges into the water body to line 52. The water body is separated from the ground by a plastic film 54.

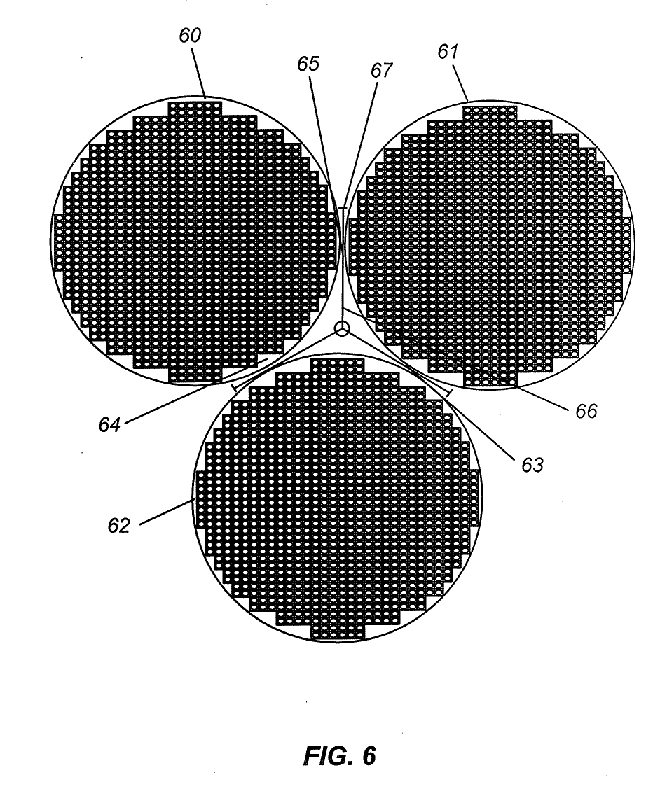

FIG. 6 shows an arrangement where three platforms 60, 61, 62 are combined into a triad. Connecting brackets 63, 64 and 65 are positioned at the area of contact; they are supported by the buoyancy of tube 66. At the end of each tube there is a concrete weight 67.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. In a solar power plant with floating rings rotating about vertical axes for tracking the azimuthal velocity of the sun, the improvement comprising: connecting brackets to fix the position of rings floating on a water layer, wherein the rings are held between rollers whose axes run almost vertical.

2. A device according to claim 1, wherein one of the rollers, which is driven by a motor, rotates the ring.

3. A device according to claim 1, whereby the device keeps two rings correctly positioned and wherein said rings are kept at a distance from each other by a wheel engaging at the outer circumference of the rings.

4. A device according to claim 1, further comprising a plurality of fixed supported rollers which roll at the inner surface of the rings.

5. A device according to claim 1, wherein: in that a wheel positioned between the rings is shaped as a sprocket wheel.

6. A device according to claim 5, comprised of a wheel between the rings being formed as a sprocket wheel and wherein each of the rings is surrounded by a roller chain into which the sprocket wheel engages.

7. A device according to claim 1, whereby the device has a bracket on which the axes of the rollers are fixed.

8. A device according to claim, 1, wherein a tube floating in the water carries the device.

9. A device according to claim 3, wherein three rings are combined to a unit and that the areas where two neighboring rings have the shortest distance from each other, a device designed for two rings, keeps the rings together.

10. A device according to claim 8, with three rings, which enclose between them an interstitial space in whose center a pillar is positioned which connects the three tubes, each of which carries a device.

11. A tube according to claim 8, whose end is connected to a heavy body.

12. A novel enhanced connecting bracket system for floating rings, comprising, in combination at least two rings;
a connecting bracket fixed to the ground; and a gear motor and sprocket arrangement linked operatively to a roller chain on the outer periphery, rollers on the bracket contacting the inner circumference; whereby floating rings are prevented from travel outside of a specified range.

13. The system of claim 12, comprised of three rings.

14. A connecting bracket set for a floating ring based solar system, which comprises, in combination;
a connecting bracket for fixing the position of at least a ring floating of a water layer;
said at least a ring being held between rollers having a substantially vertical axis; whereby tracking of the azimuthal velocity of the sun is enabled by preventing the at least a ring from migrating outside of a predetermined range, by encircling the same.

15. The system of claim 14, further comprising: a motor for rotating the at least a ring.

16. The system of claim 14, further comprising: a plurality of fixed supported rollers at the inner surface of each of the at least a ring.
